(19) United States
(12) Patent Application Publication
(10) Pub. No.: US 2019/0160904 A1
(43) Pub. Date: May 30, 2019

(54) Vehicle Wheel Suspension

(71) Applicant: Ford Global Technologies, LLC, Dearborn, MI (US)

(72) Inventors: Thomas Gerhards, Niederzier (DE); Ralf Hintzen, Aachen (DE); Daniel Mainz, Herzogenrath (DE); Rainer Souschek, Aachen (DE); Paul Zandbergen, Würselen (DE); Alberto Girelli Consolaro, Aachen (DE); Friedrich Peter Wolf-Monheim, Aachen (DE)

(73) Assignee: Ford Global Technologies, LLC, Dearborn, MI (US)

(21) Appl. No.: 16/199,984

(22) Filed: Nov. 26, 2018

(30) Foreign Application Priority Data
Nov. 29, 2017 (DE) DE102017221433.3

(51) Int. Cl. B60G 11/36

(52) U.S. Cl. CPC B60G 11/36; B60G 5/03

(57) ABSTRACT

A vehicle wheel suspension including a spring unit suspending a vehicle wheel on a vehicle body. The spring unit including a leaf spring portion extending along a Y-axis. The spring unit including a wheel carrier portion receiving a vehicle wheel. The wheel carrier portion at an end or outboard side of the leaf spring portion. The wheel carrier portion extending transversely to the leaf spring portion.

### CROSS-REFERENCE TO RELATED APPLICATIONS

Not Applicable.

### BACKGROUND OF THE INVENTION

### 1. Field of the Invention

The present invention relates to a wheel suspension for a motor vehicle; and, more specifically, to a suspension having a spring unit.

### 2. Description of Related Art

Modern motor vehicle wheel suspensions use different springs to connect the vehicle body to the vehicle wheels. Types of springs include helical springs and leaf springs. Longitudinal leaf springs may be used with rigid axles. The longitudinal leaf springs extending along a longitudinal axis of the vehicle and providing a spring suspension for an individual wheel. Transverse leaf springs are also used, the transverse leaf springs extending along a transverse axis and providing a spring suspension for two opposite wheels. The ends of the transverse leaf spring mounted, for example, through a force fit or form fit on a wheel carrier rotatably receiving the vehicle wheel. The transverse leaf spring is mounted on the vehicle body in a central region. Besides leaf springs made of spring steel, leaf springs may be made of composite material, for example a fiber-reinforced plastic. Individual springs or spring assemblies made of two or more springs can be used. A plurality of links, for example longitudinal or transverse links, connect the wheel carrier to the vehicle body and guide it during vehicle travel.

While spring systems work reliably in principle, there is an overall need for a simplified assembly that minimizes the weight or the mass, optimizes the installation space, and contributes to cost reduction.

### SUMMARY OF THE INVENTION

An uninterrupted, integral, composite material spring unit suspending a vehicle wheel on a vehicle body. The spring unit including a leaf spring portion having a longitudinal axis extending transversely to a longitudinal axis of the vehicle body, a wheel carrier portion, and a curved portion between the leaf spring portion and the wheel carrier portion. The wheel carrier portion extending transversely to the longitudinal axis of the leaf spring portion. A bearing, including an elastomeric element, connects the leaf spring portion to the vehicle body. A shock absorber connects the wheel carrier portion to the vehicle body.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more understood from the detailed description and the accompanying drawings, wherein:

FIG. 1 is a partial sectional view of a wheel suspension according to the invention in the Y-Z plane.

FIG. 2 is a partial sectional view of a wheel suspension according to the invention in the X-Y plane.

### DETAILED DESCRIPTION OF THE PREFERRED EMBODIMENTS

The following description of the preferred embodiment(s) is merely exemplary in nature and is not intended to limit the invention, its application, or uses. In the different figures, identical parts are provided with the same reference numerals, and therefore are generally described only once.

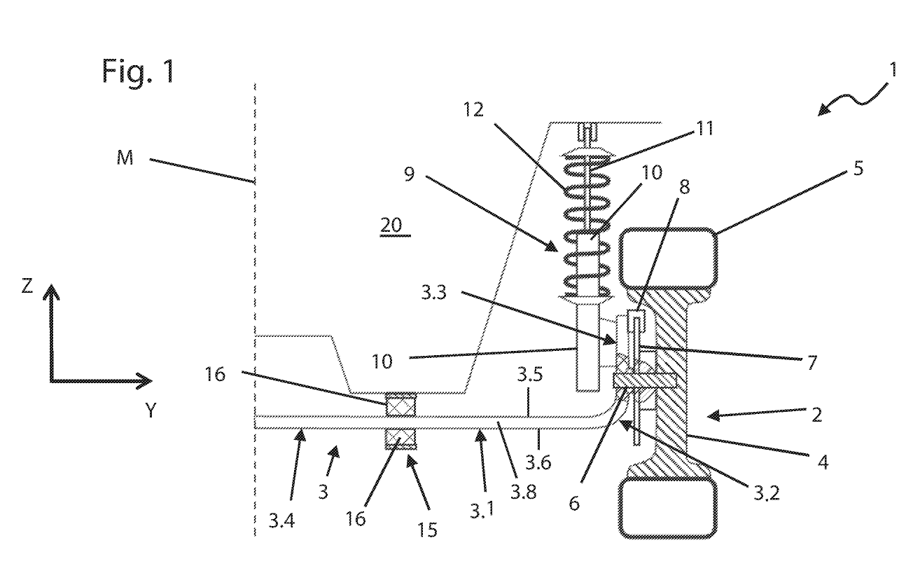

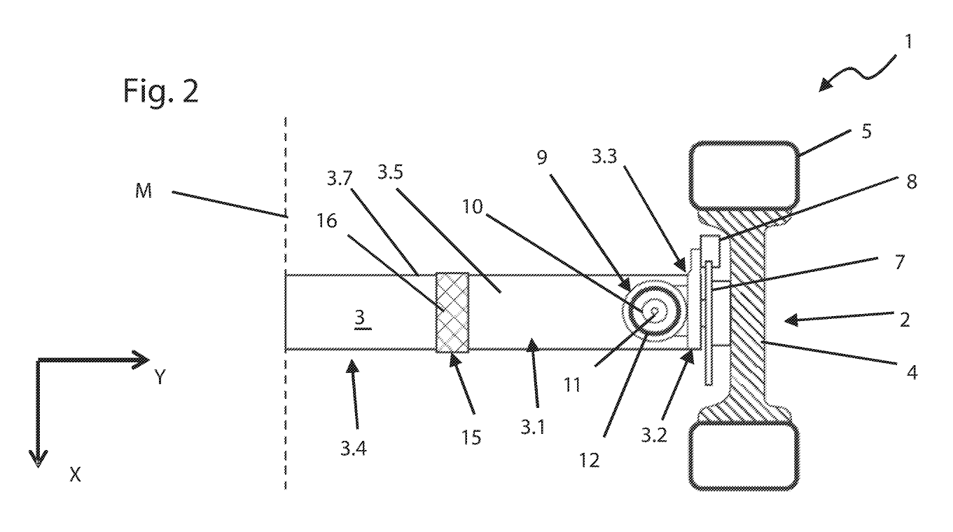

FIGS. 1 and 2 show, in a highly schematic manner, a partial sectional illustration of an embodiment of a wheel suspension 1 for a vehicle, for example a passenger car, transporter, or truck. Both views show only one half of the wheel suspension 1, which is symmetrical to a center plane M of the vehicle. As illustrated, a spring unit 3 connects the wheel 2 to a vehicle body 20. In one embodiment, the spring unit 3 is integral in its entirely and formed from fiber composite material. Integral meaning composed of constituent parts; herein, portions thereof that make up or form the spring unit 3. As shown, the spring unit 3 includes a leaf spring portion 3.1 extending in the transverse direction, along the Y-axis or transverse axis of the vehicle body 20, over a predominant part of the width of the vehicle and between the respective wheels 2 on each side of the vehicle.

In FIG. 1, the leaf spring portion 3.1 is illustrated as rectilinear with upper and lower surfaces 3.5, 3.6 and side surfaces 3.7, 3.8. In one example the leaf spring portion 3.1 extends parallel to the Y-axis, see FIG. 1 wherein the upper and lower surfaces 3.5, 3.6 extend parallel to the Y-axis; however, and additional embodiment includes the leaf spring portion 3.1 having an initial or predefined curvature within the X-Z plane, the curvature changing depending on the static or dynamic load. FIG. 1 shows the leaf spring portion 3.1 having a constant thickness, in the Z direction, between the upper and lower surfaces 3.5, 3.6 and a constant width in the X direction, between side surfaces 3.7, 3.8; however, these dimensions could also vary along the leaf spring portion 3.1.

Each wheel 2 has, in a known manner, a rim 4 and a tire 5. A wheel hub assembly 6, which may include a spindle or stub axle connected to the wheel carrier portion 3.3, for example received in an aperture of the spring unit 3, more precisely in a wheel carrier portion 3.3 of the spring unit 3 that adjoins the leaf spring portion 3.1, connects the spring unit 3 to the wheel 2. The hub assembly 6 ultimately supports the brake disc 7, wheel 2, and other components thereon. The hub assembly 6 may also be a unitary wheel bearing and hub assembly that connects directly to the wheel carrier portion 3.3.

As illustrated, the wheel 2 directly mounts on the spring unit 3 without unnecessary intermediate connection elements. The integral design of the wheel carrier portion 3.3 with the leaf spring portion 3.1 simplifies the wheel suspension 1 and its production. In addition, saving connection elements, for example, bearings for attaching the wheel carrier portion 3.3 saves weight, which is advantageous because the wheel carrier portion 3.3 is part of the unsprung mass. To ensure guidance of the wheel carrier portion 3.3 and the wheel 2 arranged thereon, transverse and/or longitudinal links for movable connection to the vehicle body 20 are normally necessary, these having been omitted in FIGS. 1, 2 for reasons of clarity. As shown a brake caliper 8 is connected to the wheel carrier portion 3.3, for example bolted to the wheel carrier portion. The brake caliper 8 including brake pads (not shown) that interact with a brake disk 7 connected to the rim 4 in a rotationally fixed manner.

The wheel carrier portion 3.3 extends upward along the Z-axis starting from the leaf spring portion 3.1. The transition between the leaf spring portion 3.1 and the wheel carrier portion 3.3 is formed as a bend, curved, or bent portion 3.2. Wherein during a relative movement of the wheel carrier portion 3.3 and the leaf spring portion 3.1 the bend or bent portion 3.2 minimizes local stresses that could otherwise overload the spring unit 3. In one embodiment, the spring element 3 is uninterrupted; no break in continuity exists, and the various portions, the leaf spring portion 3.1, bent portion 3.2, and wheel carrier portion 3.3, flow together.

The spring unit 3 extends between opposite wheels 2 and connects to the vehicle body 20 via two bearings 15 spaced apart in the Y direction, each one on respective sides of the vehicle body 20. To provide better movability of the leaf spring portion 3.1, and in particular of a central part 3.4 arranged between the bearings 15. In one embodiment the bearings 15 are elastic, with the leaf spring portion 3.1 received between two rubber elements 16. The rubber elements 16 allow a slight rotation about the X-axis, which is necessary during a spring compression movement of the wheels 2.

A shock absorber 9 damps vibrations in the wheel suspension 1. The shock absorber 9 includes a damper tube 10 rigidly connected to the wheel carrier portion 3.3 and a piston rod 11 connected to the vehicle body 20. The connection of the damper tube 10 to the wheel carrier portion 3.3 may be, for example, a form fit or bolted connection. A coil spring 12 is arranged concentrically with the shock absorber 9 and provides additional spring suspension between the wheel 2 and the vehicle body 20. The coil spring 12 may modify, to a certain extent, the effective spring constant provided by the leaf spring portion 3.1. The coil spring 12 may function as a secondary spring; i.e., an additional spring element, making it possible to adapt the effective spring constant of the suspension to the requirements of different vehicle types or variants without varying the spring unit 3.

The wheel suspension 1 while available for a motor vehicle such as a truck, transporter or a passenger car, an application for trailers is also possible. For example, a wheel suspension of a non-steered axle, such as a rear axle.

The wheel suspension 1 has a spring unit 3 designed as a spring suspension of vehicle wheels 2 on a vehicle body 20, with a leaf spring portion extending along the Y-axis. “Vehicle body” is a collective term for a bodyshell, a chassis and possibly a subframe of a respective vehicle, those parts which normally form the sprung mass. The vehicle wheels 2 arranged on opposite sides of the vehicle are movably connected to the vehicle body 20 by the wheel suspension 1. The spring unit 3 provides a spring suspension between the vehicle wheels 2 and the vehicle body 20. The spring unit 3 produces a restoring force when a vehicle wheel 2 deflects in relation to the vehicle body 20. To perform this function the spring unit 3 is at least indirectly connected both to the vehicle wheels 2 and to the vehicle body 20.

The spring unit 3 has a leaf spring portion 3.1 extending along the Y-axis—the vehicle transverse axis. In the unloaded state, the leaf spring portion 3.1 does not necessarily extend parallel to the Y-axis, but can have, for example, a curvature within the Y Z plane. References to the X-axis—longitudinal axis, Y-axis—transverse axis, and the Z-axis—vertical axis relate to the orientation of the vehicle body 20 and the state of the wheel suspension in which it is installed as intended. Correspondingly, “in the X direction” means “in the direction of the X-axis”. The leaf spring portion 3.1 extends in the transverse direction and can be considered by itself a transverse leaf spring. As customary with leaf springs, the leaf spring portion 3.1 is of flattened design; i.e., its extent in the X direction is greater than in the Z direction, for example by at least two times or at least three times. The cross section of the leaf spring portion 3.1 can be rectangular; however, deviations therefrom are also conceivable. It is also possible for the cross section to vary along the leaf spring portion 3.1, for example the leaf spring portion tapers toward the ends or toward the center.

The spring unit 3 has wheel carrier portions 3.3 receiving the vehicle wheels 2 arranged on each end side of the leaf spring portion 3.1 and designed to be at least partially integral therewith. The wheel carrier portions 3.3 rotatably receive the vehicle wheels 2, or at least indirectly mount or support the vehicle wheels 2, performing a wheel carrier function which, in the prior art, are present as separately produced parts. The respective wheel carrier portion 3.3 receives a wheel hub assembly 6 of the vehicle wheel. The wheel carrier portion can have, for example, a brake carrier plate on which a brake caliper 8 can be secured. It may also include apertures for receiving bolts or fasteners to secure the brake caliper 8 to the wheel carrier portion 3.3. In one embodiment of the invention the wheel carrier portions 3.3 are produced at least partially integral with the leaf spring portion 3.1. In the broadest sense, at least part of the respective wheel carrier portion 3.3 is produced from the same piece or part as the leaf spring portion 3.1, which includes the possibility that parts of the wheel carrier portion are produced separately. At least a portion of the wheel carrier portion 3.3 and the leaf spring portion 3.1 form integral parts of the same element. The respective wheel carrier portion 3.3 is connected in a sprung manner to the vehicle body 20 via the leaf spring portion 3.1.

Integrating the wheel carrier and the leaf spring of the spring unit simplifies production and assembly because it is no longer requires two separate parts to be dimensionally tailored and connected to one another. Connection elements such as bearings are superfluous, which, besides simplifying the assembly, also leads to a cost reduction and to a reduction in the weight or the mass. In addition, the integral design of leaf spring portion 3.1 and wheel carrier portion 3.3, makes the connection is wear-free, in contrast to a conventional attachment using bearing elements.

In one embodiment, the wheel carrier portion to 3.3 may be additionally connected to the vehicle body 20 with additional elements such as longitudinal and/or transverse links that guide the wheel carrier portion 3.3 and ensure correct alignment of the attached wheels 2. These links can be connected to the wheel carrier portion 3.3 in a conventional manner, for example by elastic bearings. While they can be used, such additional links are unnecessary, because the leaf spring portion 3.1 may take up forces acting on the wheel 2 in the longitudinal direction, making longitudinal links superfluous. Lateral forces are also taken up by the leaf spring portion 3.1, making transverse links superfluous. A camber support can be realized via a damper strut of a shock absorber 9.

In one example, part of the wheel carrier portion 3.3 could be produced separately from the leaf spring portion 3.1 and then connected. In addition, it would be conceivable for the leaf spring portion 3.1 to consist intrinsically of a plurality of pieces produced separately and then connected to one another. However, at least part of each wheel carrier portion 3.3 would be produced integrally with one piece of the leaf spring portion 3.1. To simplify production and assembly and achieve weight and cost saving, it is preferable, that the wheel carrier portions 3.3 and the leaf spring portion 3.1 are entirely integral. For example, the spring unit three is produced in its entirely, including the wheel carrier portions 3.3 and the leaf spring portion 3.1 as one piece.

The spring unit 3 may be formed from spring steel. The spring unit 3 may also be produced from composite material, providing a weight saving. The composite may be formed partially of fiber composite material. Examples of fiber composite materials are all materials in which fibers, for example, glass fibers, carbon fibers and/or aramid fibers, are incorporated for reinforcement into a polymer matrix, for example, a plastic or synthetic resin matrix. Further particles, layers or components not classified as polymers or fibers may also be incorporated or added. Producing the spring unit 3 from a composite material achieves various desired designs with a single primary forming step. Additional embodiments may include forming the spring unit 3 of locally different materials or material properties, variations of the incorporated fibers matrix materials, or other elements wherein, for example, the leaf spring portion 3.1 is more elastic than the wheel carrier portions 3.3.

Various embodiments are contemplated for attaching leaf spring portion 3.1 to the vehicle body 20. According to one embodiment, the leaf spring portion 3.1 is connected to the vehicle body 20 via two bearings 15 spaced apart in the Y direction. A central part 3.4 of the leaf spring portion 3.1 is arranged between the two bearings 15 and guided in a self-supporting manner. To allow movability of the central part 3.4, it is preferable that the leaf spring portion 3.1 is movably mounted. One embodiment includes the bearing 15 making possible a limited rotatability about the X-axis, and displacement in the Y direction and/or in the Z direction may be included. The leaf spring portion 3.1 can be deformed in an optimal manner if a force acts between the wheel carrier portions 3.3, or the wheels arranged thereon, and the vehicle body 20. In addition, the leaf spring portion 3.1, attached at the two spaced bearings 15 brings about roll stabilization, making it possible, for example, to dispense with a separate stabilizer.

In one embodiment, the bearings 15 are elastic. The bearings 15 may also be composite bearings, for example rubber-metal bearings. An elastic bearing has at least one elastomer element 16 connecting the leaf spring portion 3.1 to the vehicle body 20. The elastomer element 16 may comprise rubber, silicone or another elastomer. Such elastic bearings generally make it possible to achieve a plurality of degrees of freedom without the bearing 15 having a complicated and therefore cost-intensive design. The elastic bearing allowing the rotational and displacement movements.

To avoid undesired vibrations, it is normally necessary for the wheel suspension 1 to include at least one shock absorber or vibration damper 9. In each case a shock absorber 9 is preferably connected to the wheel carrier portion 3.3. Connecting the shock absorber 9 to the wheel carrier portion 3.3, either directly or indirectly, reduces or eliminates the need for any links. The shock absorber 9 can be designed, for example, as a hydraulic damper or air spring damper, although other design forms are also conceivable. With a hydraulic damper, it is possible for example for the damper tube to be connected to the wheel carrier portion 3.3, whereas the piston rod 11, which is movable with respect thereto, is connected to the vehicle body 20.

The shock absorber 9 can be rigidly connected to the wheel carrier portion 3.3. The corresponding connection designed as a form-fit, force-fit and/or integrally bonded connection. In each case only one part of the shock absorber 9, for example the damper cylinder 10, is rigidly connected, whereas another part, for example the piston rod 11 with the piston, is movable relative thereto.

The wheels 2 are attached to the vehicle body 20 by the leaf spring portion 3.1 alone; making further spring elements unnecessary. However, in some embodiments, further spring elements, or secondary springs, can be used in a supplementary manner for setting the effective spring constant acting on the respective wheel. According to such an embodiment, a secondary spring extends between each wheel carrier portion 3.3 and the vehicle body 20. The secondary spring can be, for example, a coil spring 12 made of spring steel or composite material. The coil spring 12 is shown herein as part of a spring-damper unit and concentrically surrounds the shock absorber 9. The coil spring 12 may also be offset thereto. If the shock absorber 9 is an air spring damper it may also act as a secondary spring. Using of a secondary spring, for example the coil spring 12, enables using the same spring unit 3 in different vehicle types or variants, wherein spring properties are individually set by using a suitable, adapted secondary spring. The leaf spring portion 3.1 of the spring unit 3 enables use of a comparatively small and weight-saving secondary spring.

Many designs are possible when producing the spring unit 3 from a composite material. For example, the leaf spring portion 3.1 could open into the wheel carrier portion 3.3 at an obtuse or right angle, resulting in a T-like structure within the Y-Z plane. According to another embodiment, each wheel carrier portion 3.3 extends on one side in the Z direction starting from the leaf spring portion 3.1, corresponding to an L-like structure within the Y-Z plane. The wheel carrier portion 3.3 can extend upward starting from the leaf spring portion 3.1; however, it can also extend downward. The form or configuration ultimately selected may depend on different factors, for example, on the available installation space for the leaf spring portion 3.1.

A transition from the leaf spring portion 3.1 to the wheel carrier portion 3.3 is preferably formed as a curved portion. For example, the leaf spring portion 3.1 merges in the manner of a bend or curve into the wheel carrier portion 3.3 which, in contrast to an angled transition, keeps local stresses low, making it possible for the spring unit 3 to be configured in a material-saving and lighter manner. The curvature also makes it possible to set the stiffness by which the wheel carrier portion 3.3 is forced by the leaf spring portion 3.1 into a defined camber position during spring compression and extension movements, with it being supported on the upper side by a damper strut of a shock absorber 9. Even though a curved transition is generally advantageous, an angled transition is also possible.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle wheel suspension comprising:
a spring unit suspending a vehicle wheel on a vehicle body, said spring unit having a leaf spring portion extending along a Y-axis;
the spring unit including a wheel carrier portion, said wheel carrier portion at least partially integral with said leaf spring portion.

2. The suspension of claim 1 wherein said wheel carrier portion and said spring portion entirely integral.

3. The suspension of claim 1 wherein said spring unit is formed of a composite material.

4. The suspension of claim 1 including a bearing connecting said leaf spring portion to said vehicle body.

5. The suspension of claim 4 wherein said bearing includes an elastomeric element.

6. The suspension of claim 1 including a shock absorber is connected to said wheel carrier portion.

7. The suspension of claim 6 wherein said shock absorber is rigidly connected to said wheel carrier portion.

8. The suspension of claim 1 including a secondary spring extends between said wheel carrier portion and said vehicle.

9. The suspension of claim 1 wherein said wheel carrier portion extends upward along a Z-axis from said spring portion.

10. The suspension of claim 1 including a curved portion between said spring portion and said wheel carrier portion.

11. A vehicle wheel suspension comprising:
an integral, composite material spring unit suspending a vehicle wheel on a vehicle body, said spring unit including a leaf spring portion having a longitudinal axis extending transversely to a longitudinal axis of said vehicle body, a wheel carrier portion, and a curved portion between said leaf spring portion and said wheel carrier portion wherein said wheel carrier portion extends transversely to said longitudinal axis of said leaf spring portion;
a bearing including an elastomeric element, said bearing connecting said leaf spring portion to said vehicle body; and
a shock absorber connected to said wheel carrier portion and said vehicle body.

12. The suspension of claim 11 including a wheel hub assembly connected to said wheel carrier portion.

13. The suspension of claim 11 including a brake caliper connected to said wheel carrier portion.

14. The suspension of claim 11 including a secondary spring extending between said wheel carrier portion and said vehicle.

15. A vehicle wheel suspension comprising:
an uninterrupted spring unit suspending a vehicle wheel on a vehicle body, said spring unit including a leaf spring portion having a longitudinal axis extending transversely to a longitudinal axis of said vehicle body, a wheel carrier portion, and a curved portion between said leaf spring portion and said wheel carrier portion wherein said wheel carrier portion extends transversely to said longitudinal axis of said leaf spring portion;
a bearing including an elastomeric element, said bearing connecting said leaf spring portion to said vehicle body;
a shock absorber rigidly connected to said wheel carrier portion and pivotally connected to said vehicle body;
a secondary spring extending between said spring unit and said vehicle body;
a hub assembly connected to said wheel carrier portion, said vehicle wheel connected to said hub assembly; and
a brake caliper connected to said wheel carrier portion.
